(19) United States
(12) Patent Application Publication
(10) Pub. No.: US 2006/0162689 A1
(43) Pub. Date: Jul. 27, 2006

(54) Method of controlling diesel engine combustion process in a closed loop using ionization feedback

(75) Inventors: James R. Winkelman, Bloomfield, MI (US); Guoming G. Zhu, Novi, MI (US); Shankar Raman, Grosse Pointe Woods, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/042,699

(22) Filed: Jan. 25, 2005

(51) Int. Cl. F02D 43/00; F02D 41/14

(52) U.S. Cl. 123/299; 123/305; 123/435

(57) ABSTRACT

A system for controlling fuel injection parameters of a diesel engine is provided. The system includes an engine cylinder, a fuel injector, a glow plug, an ionization sensor and a controller. The fuel injector provides fuel to the engine cylinder and initiates the combustion process within the engine cylinder. The ionization sensor senses ionization during the combustion process and generates an ionization signal provided to the controller. Based on the ionization signal the controller is configured to control the fuel injection parameters, such as the number of injections, quantity and timing of each fuel injection events and the maximum rate of engine exhaust gas recirculation.

### BACKGROUND

1. Field of the Invention

The present invention generally relates to a system for controlling diesel engine combustion.

2. Description of Related Art

Diesel engine fueling is typically controlled in an open loop using a look-up table obtained through an engine mapping process. As diesel fuel injection technology advances, systems have moved from a single fuel injection per combustion event to multiple fuel injections per combustion event. Multiple injections provide improved emission and fuel economy. However, obtaining optimal open-loop calibrations, or look-up tables, becomes much more difficult. Further, open loop fuel control systems require conservativeness in design such that the open loop control strategy accommodates environmental variations, engine variations, and fuel variations. As stricter emission regulations have been implemented, design limitations with an engine mapping look-up table jeopardize the ability of meeting future emission regulations.

It is also well known that exhaust gas recirculation (EGR) is used to reduce NOx emission. Systems currently control the EGR/dilution rate based on engine mapping in an open loop fashion. As such, the maximum EGR/dilution rate is determined through engine mapping. The EGR system is used to reduce the amount of NOx created by the engine. It does this by diluting the air/fuel mixture with a certain amount of inert gas (up to 50 to 60% of the total mixture); exhaust gas is used since it contains a much less amount of oxygen than the air/fuel mixture (and is readily available). Adding it has the effect of lowering the combustion temperature below the point at which nitrogen combines with oxygen to form NOx.

However, the precise amount of exhaust gas which must be metered into the intake manifold and/or trapped inside the cylinder varies significantly as engine load changes. Accordingly the EGR system must be controlled carefully to maintain a fine line between good NOx control and good engine performance. If too much exhaust gas is metered, engine performance will suffer (such as bad combustion stability). If too little exhaust gas is metered, the engine may not meet emission standards. The volume of recirculated exhaust gas with respect to the total gas volume is referred to as the EGR rate. Generally, the EGR rate is a function of the engine operational conditions.

Controlling the EGR system using an open loop leads to two main disadvantages. One is the conservativeness associated with open loop control scheme, and the other is long calibration process associated with a high mapping cost. The long calibration process for engine mapping is caused by the large number of control parameters that need to be optimized and the conservativeness of the open loop control scheme is associated with the engine-to-engine variation, engine aging, and the variation of the engine operational conditions, etc.

In view of the above, it is apparent that there exists a need for an improved system for controlling diesel engine combustion.

### SUMMARY

In satisfying the above need, as well as overcoming the enumerated drawbacks and other limitations of the related art, the present invention provides an improved system for controlling diesel engine combustion.

The system controls both engine fuel injection process (timing and volume of each injection) and maximum dilution rate (while maintaining engine combustion stability) in a closed loop fashion to reduce the conservativeness due to conventional open loop design, resulting in reduced emissions and improved fuel economy. Further, the closed loop control requires less engine mapping time for calibration than the open loop controllers for fuel injection and maximum EGR/dilution control and the control system is also robust to engine-to-engine variations, engine aging, and environmental changes.

The system includes an engine cylinder, a fuel injector, a glow plug with integrated ionization sensor and an engine controller. The fuel injector provides fuel to the engine cylinder and the glow plug heats up the air/fuel mixture to certain temperature to make compression ignition possible. The integrated ionization sensor senses ions generated during the combustion process and generates an ionization signal that is provided to the controller. Based on the ionization signal, the controller is configured to control the fuel injection parameters, such as the quantity and timing of fuel injection events. Further, the number of multiple fuel injection events or a continuous rate shaping of the fuel injected into the engine cylinder may be manipulated by the controller based on the ionization signal.

The controller uses the ionization signal to calculate a combustion quality measurement and compares the combustion quality measurement to a desired combustion quality criteria. The combustion quality measurement may include a heat release rate of the engine and the desired combustion quality criteria may include a desired heat release rate. The difference between the desired and actual heat release rate can be used to decide the number of fuel injection events, quality of timing of each injection event, along with the engine operational conditions such as engine speed and desired torque.

Based on the ionization signal, the controller is also configured to control exhaust gas recirculation parameters, such as, the rate of exhaust gas recirculation. To be more specific, regulating the EGR valve position to the desired EGR rate. Further, the controller is configured to adjust the gas recirculation and dilution control strategy based on a combustion stability measurement calculated using the ionization signal. The combustion stability measure calculated from ionization signal is similar to COVariance of Indicated Mean Effective Pressure (IMEP) obtained from in-cylinder pressure signal. The controller regulates the desired EGR rate based upon the difference between the combustion stability measurement generated from ionization signal and the desired combustion stability.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a cross-sectional view of a diesel engine embodying the principles of the present invention;

FIG. 2 is a typical ionization signal comparing to a heat release rate curve calculated from ionization signal; and

FIG. 3 is a schematic view of a control architecture for a diesel engine in accordance with the present invention.

### DETAILED DESCRIPTION

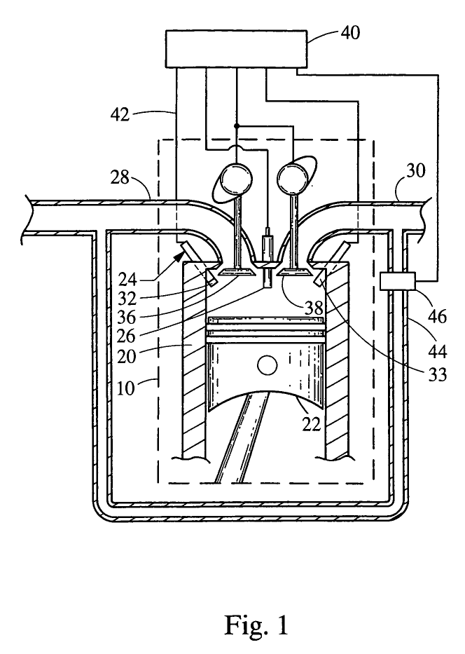

Referring now to FIG. 1, a system 12 embodying the principles of the present invention is illustrated therein. The system generally includes an engine 10 and a controller 14.

The engine 10 is shown as a diesel combustion engine having a piston 22, a cylinder 20, a fuel injector 26, a glow plug 24 integrated with ionization detection element 32, an intake valve 36, and an exhaust valve 38. As will be apparent from the discussion that follows, the engine 10 could be provided with any number of cylinders and the system 12 readily adapted thereto. Each cylinder 20 houses a piston 22 mounted for reciprocal movement therein. Combustion in the cylinder 20 will cause movement of the piston 22 resulting in a rotation of a crankshaft (not shown), which is used to transfer power from the engine 10 to the drivetrain and other systems within the vehicle.

Air and EGR gas entering the cylinder 20 from the intake manifold 28 during the intake stroke. If the intake air temperature is low, the glow plug 24 is turned on to increase the temperature of gas mixture. After the intake valve 36 is closed, the trapped gas mixture is compressed while the cylinder 22 moves upward and the gas mixture temperature rise rapidly. When the fuel injector 26 injects the fuel into cylinder 20 near the Top Dead Center (TDC) crank location, due to high gas temperature combustion occurs in the cylinder 20 right after start of injection thereby creating motion of the piston 22. To create continuous rotation of the crank shaft, the pistons 22 are positioned at varying engine angles relative to the crank shaft and the controller 40 synchronizes combustion in each cylinder to cause a smooth rotation of the crank shaft. After combustion, exhaust gasses are forced out of the cylinder 20, as the piston 22 rises on the next part of its cycle and exit through the exhaust manifold 30.

Additionally, a controller 40 optimizes the engine combustion performance by controlling a number of injection events and both injection timing and quantities of the fuel injectors 26 and EGR rate.

There are two ways to control the EGR rate. One is to use an external EGR path to re-circulate exhaust back into the intake manifold. In this case, an exhaust gas recirculation passage 44 is connected between the exhaust manifold 30 and the intake manifold 28. The controller 40 actuates the EGR valve 46 to control the amount of exhaust gas or the EGR rate provided to the intake manifold 28. The other is to control the EGR rate internally through intake and exhaust valve actuation. In this case, the air flow into the cylinder 20 can be controlled through intake valve 36 timing which can be manipulated by the controller 40; and the exhaust flow can be controlled through exhaust valve 38 by the controller 40. By controlling the exhaust valve 38 closing timing, one can control the amount of exhaust gas trapped inside cylinder 20, that is, control the EGR rate.

An ionization sensor 32 integrated with glow plug 24 is disposed in the cylinder 20 to provide an ionization signal 42 to the controller 40. Although the ionization sensor 32 is shown integrated into the glow plug 24, an ionization sensor that is separated from the glow plug 24 may also be used as depicted by reference numeral 33. During the combustion process in cylinder 20, the chemical reaction generates ions. By applying a DC bias voltage to the ionization sensing element 32 at the tip of the glow plug, ionization current can be detected.

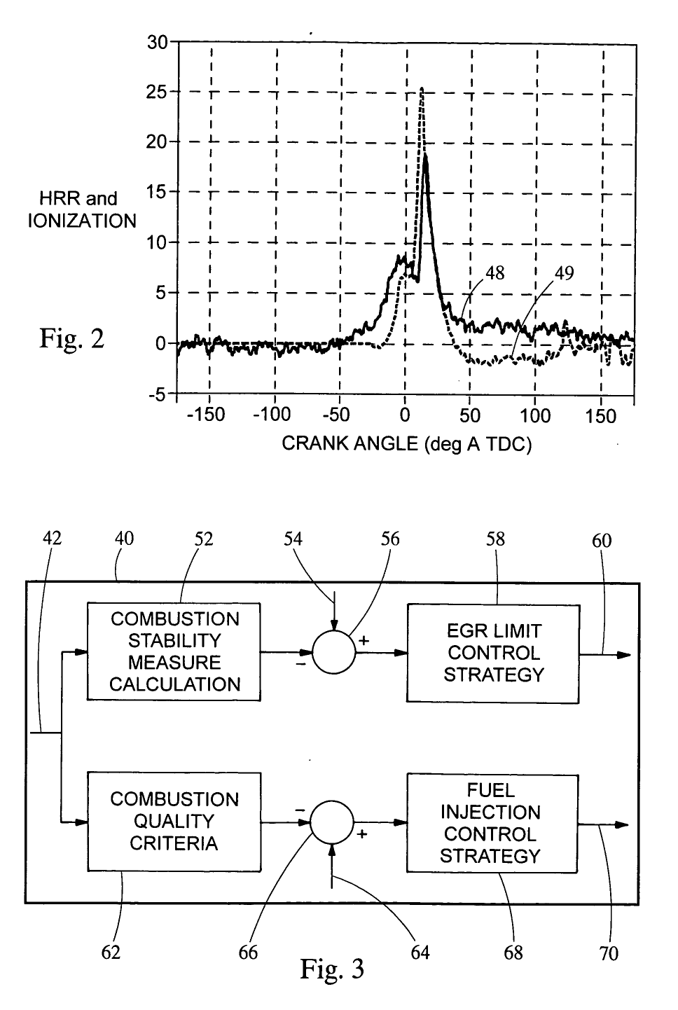

FIG. 2 shows a typical diesel ionization 48 signal with dual fuel injection events (one pre-injection and one main injection) compared to the heat release rate curve 49 calculated from an in-cylinder pressure signal. It can be observed that the ionization signal 48 shows two peaks corresponding to the two injection events. The shape of the ionization signal 48 is very close to the heat release rate curve 49 calculated from the in-cylinder pressure signal. Accordingly, using the ionization signal 42, a combustion quality measure can be generated as a feedback measure and the controller 40 can control number of injection per combustion event, the fuel injection timing and quantity for each injection for optimal fuel economy and emissions.

The ionization signal 42 can also be used by the controller 40 to generate a combustion stability measure. Using the combustion stability measure as feedback, the controller 40 can control the EGR rate through either external EGR valve 46 or intake valve 36 and exhaust valve 38 timing.

Now referring to FIG. 3, a control architecture for optimizing fuel injection parameters and EGR parameters is provided. The ionization signal 42 from the ionization sensor 32 is provided the controller 40. The controller 40 adjusts diesel engine fueling (including number of fuel injection event, injection timing and quantity of each injection) and max EGR/dilution rate using the ionization signal 42 as feedback.

As such, the system reduces engine NOx emissions by regulating combustion heat release rate (HRR) through the timing and quantity of multiple fuel injections and/or continuous rate shaping of the fuel injection profile based on the ionization feedback. Further, the system controls the maximum EGR/dilution limit using the combustion stability criterion calculated from diesel ionization signal. As a result of controlling both fuel injection and max EGR/dilution limit in a closed loop fashion, based on the ionization signal 42, the engine can operated at its max EGR/dilution limit for reduced emissions and improved fuel economy, while maintaining engine combustion stability.

The control architecture of controller 40 provides two independent control loops for engine fuel injection and maximum dilution limit control, respectively. With regard to maximum dilution limit control, the combustion stability measure calculation block 52 receives the ionization signal 42 and calculates a combustion stability measurement based on the ionization signal 42. One method of calculating the combustion stability measurement is by calculating the equivalent covariance of the indicated mean effective pressure (IMEP) based on the ionization signal. Due to engine NVH (Noise, vibration, and heat) issue, it is generally desired to keep the covariance of IMEP below a predetermined percentage, such as 3%. The maximum amount of EGR/dilution that can be applied is limited by the required covariance of IMEP limit, because the covariance of IMEP increases in relation to the EGR/dilution. Generally, test results have shown that the ionization signal 42 can be reasonably used to calculate the covariance of IMEP of the engine.

The combustion stability measurement is provided to summer 56 and compared with a desired combustion stability signal 54, also expressed in terms of a desired covariance of IMEP profile, to provide a combustion stability error signal that is provided to the EGR limit Control Strategy block 58. The EGR Limit Control Strategy block 58 uses the combustion stability error signal and calculates the amount of EGR/dilution required for correction. As mentioned above, EGR is generally maximized until combustion stability is compromised. The EGR limit control strategy block 58 generates an EGR control signal that adjusts the position of the EGR valve 46 or intake and exhaust valve timing to provide the amount of EGR dilution required.

With regard to fuel injection control, the combustion quality measure calculation block 62 receives the ionization signal 42 and calculates a combustion quality measurement based on the ionization signal 42. One method of calculating the combustion quality measurement is by calculating an HRR based on the ionization signal 42. Generally, tests have shown that the ionization signal corresponds to and can be reasonable used to calculate the HRR of the engine.

The combustion quality measurement is provided to summer 66 and compared with a desired combustion quality signal 64, generally expressed as a desired HRR profile, to provide a combustion quality error signal that is provided to the Fuel Injection Control Strategy block 68. The Fuel Injection Control Strategy block 68 uses the curve of the combustion stability error signal and calculates the number of injection events, quantity and timing of each fuel injection required for correction. Closed loop fueling control allows adjusting fuel injection timings and quantities of a multiple fuel injection events or continuous rate shaping to regulate the HRR. For example, a five-injection-event command may have ten parameters, five injection timing and five injection durations. The Fuel Injection Control Strategy block 68 generates a fuel injection control signal that manipulates the fuel injectors to correct the HRR to the desired HRR, for reduced NOx emissions.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. A system for controlling a diesel engine combustion, the system comprising:
an engine cylinder;
a fuel injector in fluid communication with the engine cylinder to provide fuel to the engine cylinder;
a glow plug located within the engine cylinder to heat a fuel mixture in the engine cylinder;
an ionization sensor adapted to provide an ionization signal; and
a controller coupled to the ionization sensor and the fuel injector to control fuel injection parameters based on the ionization signal.

2. The system according to claim 1, wherein the ionization sensor is integrated with the glow plug.

3. The system according to claim 1, wherein the ionization sensor is separated from the glow plug.

4. The system according to claim 1, wherein the fuel injection parameters include fuel injector timing.

5. The system according to claim 1, wherein the fuel injection parameters include fuel injection quantity.

6. The system according to claim 1, wherein the fuel injection parameters include quantity and timing of multiple fuel injection events.

7. The system according to claim 1, wherein the fuel injection parameters include continuous rate shaping of the fuel injected into the engine cylinder.

8. The system according to claim 1, wherein the fuel injection parameters are controlled to regulate a heat release rate of the engine.

9. The system according to claim 1, wherein the controller calculates combustion quality measurement based on the ionization signal and compares the combustion quality measurement to a desired combustion quality criteria.

10. The system according to claim 9, wherein the combustion quality measurement includes a heat release rate of the engine and the desired combustion quality criteria includes a desired heat release rate.

11. The system according to claim 1, wherein the ionization sensor generates the ionization signal based on a current measurement between two electrodes.

12. A system for controlling a diesel engine combustion, the system comprising:
an engine cylinder;
a fuel injector in fluid communication with the engine cylinder to provide fuel to the engine cylinder;
a glow plug located within the engine cylinder to heat a fuel mixture in the engine cylinder;
an ionization sensor adapted to provide an ionization signal;
an inlet valve and an exhaust valve, in communication with the cylinder;
an exhaust gas recirculation valve in fluid communication with the exhaust valve; and
a controller coupled to the ionization sensor, the fuel injector, and the exhaust gas recirculation valve, the controller being configured to control fuel injection parameters and exhaust gas recirculation parameters based on the ionization signal.

13. The system according to claim 11, wherein the ionization sensor is integrated with the glow plug.

14. The system according to claim 12, wherein the controller is configured to adjust an exhaust gas recirculation and dilution control strategy based on a combustion stability measurement.

15. The system according to claim 12, wherein the controller is configured to control an exhaust gas recirculation valve based on the ionization signal.

16. The system according to claim 12, wherein the controller is configured to control ignition timing based on the ionization signal.

17. The system according to claim 12, wherein the controller is configured to control valve timing based on the ionization signal.

18. The system according to claim 12, wherein the controller is configured to compare a measured combustion stability to a desired combustion stability.

19. The system according to claim 18, wherein the measured combustion stability includes a covariance of the integrated mean effective pressure.

20. The system according to claim 11, wherein the fuel injection parameters include fuel injector timing.

21. The system according to claim 11, wherein the fuel injection parameters include fuel injection quantity.

22. The system according to claim 12, wherein the fuel injection parameters include quantity and timing of multiple fuel injection events.

23. The system according to claim 12, wherein the controller calculates combustion quality measurement based on the ionization signal and compares the combustion quality measurement to a desired combustion quality criteria.

24. The system according to claim 23, wherein the combustion quality measurement includes a heat release rate of the engine and the desired combustion quality criteria includes a desired heat release rate.
